(19) United States
(12) Patent Application Publication
(10) Pub. No.: US 2018/0247563 A1
(43) Pub. Date: Aug. 30, 2018

(54) TRAINING SYSTEMS FOR SECURE SOFTWARE CODE

(71) Applicants: Pieter Danhieux, Rozelle, New South Wales (AU); John Fitzgerald, London (GB); Secure Code Warrior Limited, Northampton (GB)

(72) Inventors: Pieter Danhieux, Rozelle, New South Wales (AU); John Fitzgerald, London (GB)

(21) Appl. No.: 15/527,953

(22) PCT Filed: Nov. 6, 2015
(86) PCT No.: PCT/AU2015/000675

§ 371 Date: May 18, 2017

(30) Foreign Application Priority Data
Nov. 18, 2014 (AU) 2014904632

(51) Int. Cl. G09B 19/00; G09B 7/07

(52) U.S. Cl. CPC G09B 19/0053; G09B 7/07

(57) ABSTRACT

A training system for providing training facilities for users to learn secure coding techniques, the training system comprising: a computer server system comprising one or more computer processors and memory for storing computer code, said computer code, when executed by said processors, being adapted to; provide means for provision of a plurality of unique user accounts and means for a user to securely access an associated user account; serve insecure software code example snippets to a user interface for review by said user; processing a solution to said insecure code snippets, said solution being entered via user interface by said user; and providing feedback to said user regarding the validity of said solution.

### FIELD OF THE INVENTION

The present invention relates to training systems and in particular to software applications for training systems.

The invention has been developed primarily for use as a software application for training software developer users to learn secure coding techniques and will be described hereinafter with reference to this application. However, it will be appreciated that the invention is not limited to this particular field of use.

### BACKGROUND

Any discussion of the background art throughout the specification should in no way be considered as an admission that such background art is prior art nor that such background art is widely known or forms part of the common general knowledge in the field.

There is more and more pressure on organizations to ensure that their software applications are secure. The impact of a security breach can have both significant financial and reputation costs for an organization and their customers.

Many information security problems are related to errors in the software application code of the software applications used by the organisation. Ensuring that application code is written securely in the first place can significantly reduce the effort to identify and remediate vulnerabilities at the end of the development lifecycle or once the application has been deployed. There are proven cost benefits of finding and addressing vulnerabilities early in the development lifecycle.

Companies involved with developing software applications want to have assurance on the software security skills of software applications that are outsourced or developed offshore in a consultancy arrangement. Generally, however, there is a lack of software developers who fully understand security weaknesses in software code.

Therefore, a significant problem for organisations developing software applications is the identification of training needs for their software development community and individual software developers. For instance, the organisation would like to be able to utilise a reliable system for determining which of the software developers they employed or engage our knowledgeable in terms of developing software with secure code and ponderously which of those developers or contractors require additional training.

Additionally, contractors presenting themselves as candidates for a development project often have difficulties convincing potential employers of their competence in terms of developing secure software code and secure applications.

Accordingly, a need exists for a development and training system for software developers in the field of secure software coding with the ability to rank and/or certify a software developer's competence in developing secure software applications.

### SUMMARY

It is an object of the present invention to overcome or ameliorate at least one of the disadvantages of the prior art, or to provide a useful alternative.

Disclosed herein is a practical, hands-on, interactive learning system that enables software developer users to master how to code securely, and to do so in a range of development languages and programming frameworks. The system goes beyond simple basic multiple-choice testing by offering practical scenarios that developers face in the real world. Developers are often provided with software code from applications that contain one or more security vulnerabilities. They are then challenged to identify and analyse these security vulnerabilities and select or develop an appropriate fix.

The training systems disclosed and are designed to be useful for entry-level professionals developing their secure coding skills, through to seasoned experts learning to fix more challenging security vulnerabilities.

According to a first aspect of the invention, there is provided a training system for providing training facilities for users to learn secure coding techniques. The training system may comprise a computer server system comprising one or more computer processors and memory for storing computer code. The computer code, when executed by the processors, may be adapted to provide means for provision of a plurality of unique user accounts and means for a user to securely access an associated user account. The computer code may be further adapted to serve insecure software code example snippets to a user interface for the user to identify one or more vulnerabilities in said insecure software code example snippets. The computer code may be further adapted to process a solution to said one or more vulnerabilities in the insecure software code example snippets, the solution being entered via a user interface by the user. The computer may be further adapted to provide feedback to the user regarding the validity of the solution.

According to an arrangement of the first aspect, there is provided a training system for providing training facilities for users to learn secure coding techniques. A computer server system comprising one or more computer processors and memory for storing computer code, the computer code, when executed by the processors, being adapted to: provide means for provision of a plurality of unique user accounts and means for a user to securely access an associated user account; serve insecure software code example snippets to a user interface for the user to identify one or more vulnerabilities in said insecure software code example snippets; process a solution to said one or more vulnerabilities in the insecure software code example snippets, the solution being entered via a user interface by the user; and provide feedback to the user regarding the validity of the solution.

The solution may comprise a selection by the user from a plurality of possible solutions. The solution may comprise amended software code submitted by the user.

The feedback to the users may be indicative of a level of competency of the user with secure coding techniques.

The user may comprise a software developer.

According to a second aspect, there is provided a training method for training users in secure software coding competency. The method may comprise the step of providing a computer server system comprising one or more computer processors and memory for storing computer code, the computer code, when executed by the processors, being adapted to serve a training system to the users. The method may further comprise the step of providing means for provision of a plurality of unique user accounts and means for a user to securely access their account. The method may further comprise the step of serving examples of insecure software code snippets to a user interface for the user to identify one or more vulnerabilities in said insecure software code example snippets. The method may further comprise the step of processing a solution to said one or more vulnerabilities in said insecure software code example snippets, the solution being entered via a user interface by the user. The method may further comprise the step of and providing feedback to the user regarding the validity of the solution.

According to an arrangement of the second aspect there is provided a training method for training users in secure software coding competency, the method comprising the steps of: providing a computer server system comprising one or more computer processors and memory for storing computer code, the computer code, when executed by the processors, being adapted to serve a training system to the users; providing means for provision of a plurality of unique user accounts and means for a user to securely access their account; serve examples of insecure software code snippets to a user interface for the user to identify one or more vulnerabilities in said examples of insecure software code snippets; process a solution to said one or more vulnerabilities in said examples of insecure software code snippets, the solution being entered via a user interface by the user; and providing feedback to the user regarding the validity of the solution.

The serving of insecure coding examples to the user interface may comprise accompanying the example code snippets with a plurality of possible solutions for review and selection by the user of one of the possible solutions for review.

The solution entered by the user may comprise software code necessary to transform the insecure software code example into a secure software code snippet.

The feedback provided to the user may comprise a competency rank for the user with respect to a selected group or sub-set of users registered with the training system. The selected subset of users may comprise a plurality of users associated with a common employer.

According to a third aspect, there is provided a computer program product. The computer program product may comprise a computer readable medium. The computer readable medium may comprise a computer program recorded therein for providing training facilities for users to learn secure coding techniques. The computer program product may comprise means for provision of a plurality of unique user accounts. The computer program product may further comprise means for a user to securely access an associated user account The computer program product may further comprise an application module adapted to serve insecure software code example snippets to a user interface for the user to identify one or more vulnerabilities in said insecure software code example snippets. The computer program product may further comprise providing an input means to allow the user to enter via a user interface a solution to said one or more vulnerabilities in said insecure software code example snippets. The computer program product may further comprise a processing application module for processing the solution. The computer program product may further comprise providing feedback to the user regarding the validity of the solution.

According to an arrangement of the third aspect there is provided a computer program product having a computer readable medium having a computer program recorded therein for providing training facilities for users to learn secure coding techniques the computer program product comprising: means for provision of a plurality of unique user accounts and means for a user to securely access an associated user account; an application module adapted to serve insecure software code example snippets to a user interface for the user to identify one or more vulnerabilities in said insecure software code example snippets; providing an input means to allow the user to enter via a user interface a solution to said one or more vulnerabilities in said insecure software code example snippets; a processing application module for processing the solution; and providing feedback to the user regarding the validity of the solution.

The computer program product further comprises a ranking application module adapted to determine a competency rank for the user with respect to a selected group or sub-set of users registered with the training system.

According to a fourth aspect, there is provided a computer program for providing training facilities for users to learn secure coding techniques. The program may comprise code for provision of a plurality of unique user accounts, the program may further comprise code for means for a user to securely access an associated user account. The program may further comprise code for serving insecure software code example snippets to a user interface for the user to identify one or more vulnerabilities in said insecure software code example snippets. The program may further comprise code for processing a solution to said one or more vulnerabilities in the insecure software code example snippets, the solution being entered via a user interface by the user. The program may further comprise code for providing feedback to the user regarding the validity of the solution.

According to an arrangement of the fourth aspect there is provided a computer program for providing training facilities for users to learn secure coding techniques, the program comprising: code for provision of a plurality of unique user accounts and means for a user to securely access an associated user account; code for serving insecure software code example snippets to a user interface for the user to identify one or more vulnerabilities in said insecure software code example snippets; code for processing a solution to said one or more vulnerabilities in the insecure software code example snippets, the solution being entered via a user interface by the user; and code for providing feedback to the user regarding the validity of the solution.

According to a fifth aspect, there is provided a computer program element. The computer program element may comprise computer program code means to make a computer execute a procedure to providing training facilities for users to learn secure coding techniques. The computer program element may comprise means for provision of a plurality of unique user accounts and means for a user to securely access an associated user account. The computer program element may further comprise means to serve insecure software code example snippets to a user interface for the user to identify one or more vulnerabilities in said insecure software code example snippets. The computer program element may further comprise means for processing a solution to said one or more vulnerabilities in the insecure software code example snippets. The solution may be entered via a user interface by the user. The computer program element may further comprise means for providing feedback to the user regarding the validity of the solution.

According to an arrangement of the fifth aspect there is provided a computer program element comprising computer program code means to make a computer execute a procedure to providing training facilities for users to learn secure coding techniques, the computer program element comprising: provide means for provision of a plurality of unique user accounts and means for a user to securely access an associated user account; serve insecure software code example snippets to a user interface for the user to identify one or more vulnerabilities in said insecure software code example snippets; processing a solution to said one or more vulnerabilities in the insecure software code example snippets, the solution being entered via a user interface by the user; and providing feedback to the user regarding the validity of the solution.

According to a sixth aspect, there is provided a computer readable medium, having a program recorded thereon, where the program is configured to make a computer execute a procedure to provide training facilities for users to learn secure coding techniques: provide means for provision of a plurality of unique user accounts and means for a user to securely access an associated user account; serve insecure software code example snippets to a user interface for the user to identify one or more vulnerabilities in said insecure software code example snippets; processing a solution to said one or more vulnerabilities in the insecure software code example snippets, the solution being entered via a user interface by the user; and providing feedback to the user regarding the validity of the solution.

According to an arrangement of the sixth aspect, there is provided a computer readable medium, having a program recorded thereon, where the program is configured to make a computer execute a procedure to provide training facilities for users to learn secure coding techniques: provide means for provision of a plurality of unique user accounts and means for a user to securely access an associated user account; serve insecure software code example snippets to a user interface for the user to identify one or more vulnerabilities in said insecure software code example snippets; processing a solution to said one or more vulnerabilities in the insecure software code example snippets, the solution being entered via a user interface by the user; and providing feedback to the software developer regarding the validity of the solution.

### BRIEF DESCRIPTION OF THE DRAWINGS

Notwithstanding any other forms which may fall within the scope of the present invention a preferred arrangement/preferred arrangements of the invention will now be described, by way of example only, with reference to the accompanying drawings in which:

FIG. 1 shows a computing device on which the various arrangements described herein may be implemented in accordance with an arrangement of the present invention;

FIG. 2 shows a network of computing devices on which the various arrangements described herein may be implemented in accordance with an arrangement of the present invention;

FIG. 3 is a functional depiction of a skills assessment platform according to the training systems disclosed herein; and

FIG. 4 shows a representation of the factors incorporated into the challenges associated with skills assessment platform according to the training systems disclosed herein.

### DEFINITIONS

The following definitions are provided as general definitions and should in no way limit the scope of the present invention to those terms alone, but are put forth for a better understanding of the following description.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein. For the purposes of the present invention, additional terms are defined below. Furthermore, all definitions, as defined and used herein, should be understood to control over dictionary definitions, definitions in documents incorporated by reference, and/or ordinary meanings of the defined terms unless there is doubt as to the meaning of a particular term, in which case the common dictionary definition and/or common usage of the term will prevail.

The terminology used herein is for the purpose of describing particular arrangements only and is not intended to be limiting of the invention. As used herein, the singular articles “a”, “an” and “the” are intended to include the plural forms as well, unless the context clearly indicates otherwise and thus are used herein to refer to one or to more than one (i.e. to “at least one”) of the grammatical object of the article. By way of example, the phrase “an element” refers to one element or more than one element.

The term “about” is used herein to refer to quantities that vary by as much as 30%, preferably by as much as 20%, and more preferably by as much as 10% to a reference quantity. The use of the word ‘about’ to qualify a number is merely an express indication that the number is not to be construed as a precise value.

Throughout this specification, unless the context requires otherwise, the words “comprise”, “comprises” and “comprising” will be understood to imply the inclusion of a stated step or element or group of steps or elements but not the exclusion of any other step or element or group of steps or elements.

The term “real-time” for example “displaying real-time data,” refers to the display of the data without intentional delay, given the processing limitations of the system and the time required to accurately measure the data.

As used herein, the term “exemplary” is used in the sense of providing examples, as opposed to indicating quality. That is, an “exemplary embodiment” is an embodiment provided as an example, as opposed to necessarily being an embodiment of exemplary quality for example serving as a desirable model or representing the best of its kind.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of”, “consisting essentially of,” when used in the claims, shall have its ordinary meaning as used in the field of patent law.

As used herein in the specification and in the claims, the phrase “at least one” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the summary above and the description below, all transitional phrases such as “comprising,” “including,” “carrying,” “having,” “containing,” “involving,” “holding,” “composed of,” and the like are to be understood to be open-ended, i.e., to mean “including but not limited to”. Only the transitional phrases “consisting of” and “consisting essentially of” alone shall be closed or semi-closed transitional phrases, respectively.

For the purpose of this specification, where method steps are described in sequence, the sequence does not necessarily mean that the steps are to be carried out in chronological order in that sequence, unless there is no other logical manner of interpreting the sequence.

In addition, where features or aspects of the invention are described in terms of Markush groups, those skilled in the art will recognise that the invention is also thereby described in terms of any individual member or subgroup of members of the Markush group.

### DETAILED DESCRIPTION

It should be noted in the following description that like or the same reference numerals in different embodiments denote the same or similar features.

There will now be described a network of computing devices on which the various embodiments described herein may be implemented. The network of computing devices will be described in relation to a software application system and method for training software developers to learn secure coding techniques.

As will become apparent in the description below, the method and computing devices for providing the training system may substantially ameliorate the above-mentioned drawbacks of the background art.

### Computing Device

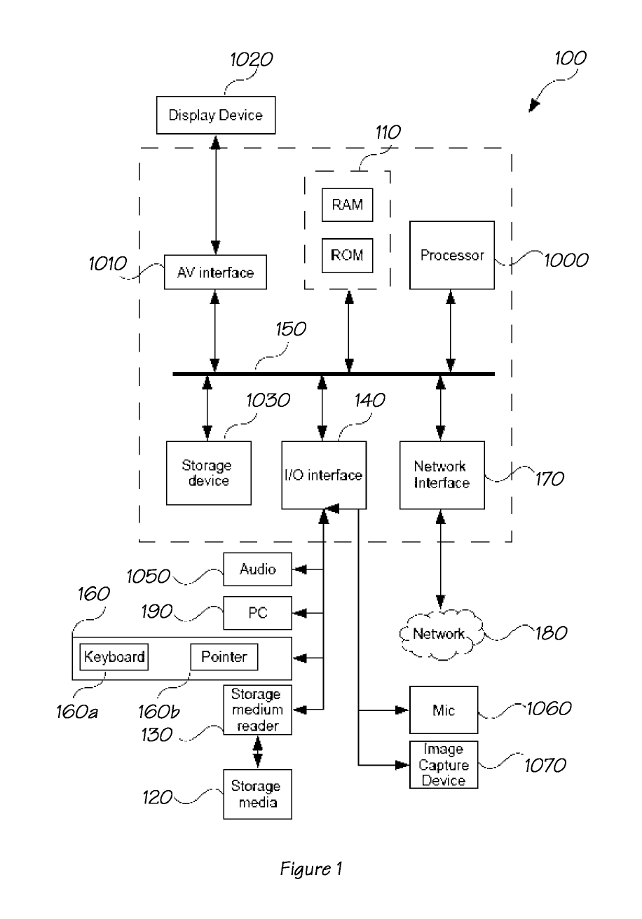

FIG. 1 shows a computing device 100 on which the various embodiments described herein may be implemented. In particular the steps of the method of recreating a user interface interaction may be implemented as computer program code instructions executable by the computing device 100. The computer program code instructions may be divided into one or more computer program code instruction libraries, such as dynamic link libraries (DLL), wherein each of the libraries performs a one or more steps of the method. Additionally, a subset of the one or more of the libraries may perform graphical user interface tasks relating to the steps of the method.

The device 100 comprises semiconductor memory 110 comprising volatile memory such as random access memory (RAM) or read only memory (ROM). The memory 100 may comprise either RAM or ROM or a combination of RAM and ROM.

The device 100 comprises a computer program code storage medium reader 130 for reading the computer program code instructions from computer program code storage media 120. The storage media 120 may be optical media such as CD-ROM disks, magnetic media such as floppy disks and tape cassettes or flash media such as USB memory sticks.

The device further comprises I/O interface 140 for communicating with one or more peripheral devices. The I/O interface 140 may offer both serial and parallel interface connectivity. For example, the I/O interface 140 may comprise a Small Computer System Interface (SCSI), Universal Serial Bus (USB) or similar I/O interface for interfacing with the storage medium reader 130. The I/O interface 140 may also communicate with one or more human input devices (HID) 160 such as keyboards, pointing devices, joysticks and the like. The I/O interface 140 may also comprise a computer to computer interface, such as a Recommended Standard 232 (RS-232) interface, for interfacing the device 100 with one or more personal computer (PC) devices 190. The I/O interface 140 may also comprise an audio interface for communicate audio signals to one or more audio devices 1050, such as a speaker or a buzzer.

The device 100 also comprises a network interface 170 for communicating with one or more computer networks 180. The network 180 may be a wired network, such as a wired Ethernet™ network or a wireless network, such as a Bluetooth™ network or IEEE 802.11 network. The network 180 may be a local area network (LAN), such as a home or office computer network, or a wide area network (WAN), such as the Internet or private WAN.

The device 100 comprises an arithmetic logic unit or processor 1000 for performing the computer program code instructions. The processor 1000 may be a reduced instruction set computer (RISC) or complex instruction set computer (CISC) processor or the like. The device 100 further comprises a storage device 1030, such as a magnetic disk hard drive or a solid state disk drive.

Computer program code instructions may be loaded into the storage device 1030 from the storage media 120 using the storage medium reader 130 or from the network 180 using network interface 170. During the bootstrap phase, an operating system and one or more software applications are loaded from the storage device 1030 into the memory 110. During the fetch-decode-execute cycle, the processor 1000 fetches computer program code instructions from memory 110, decodes the instructions into machine code, executes the instructions and stores one or more intermediate results in memory 100.

In this manner, the instructions stored in the memory 110, when retrieved and executed by the processor 1000, may configure the computing device 100 as a special-purpose machine that may perform the functions described herein.

The device 100 also comprises a video interface 1010 for conveying video signals to a display device 1020, such as a liquid crystal display (LCD), cathode-ray tube (CRT) or similar display device.

The device 100 also comprises a communication bus subsystem 150 for interconnecting the various devices described above. The bus subsystem 150 may offer parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like.

### Network of Computing Devices

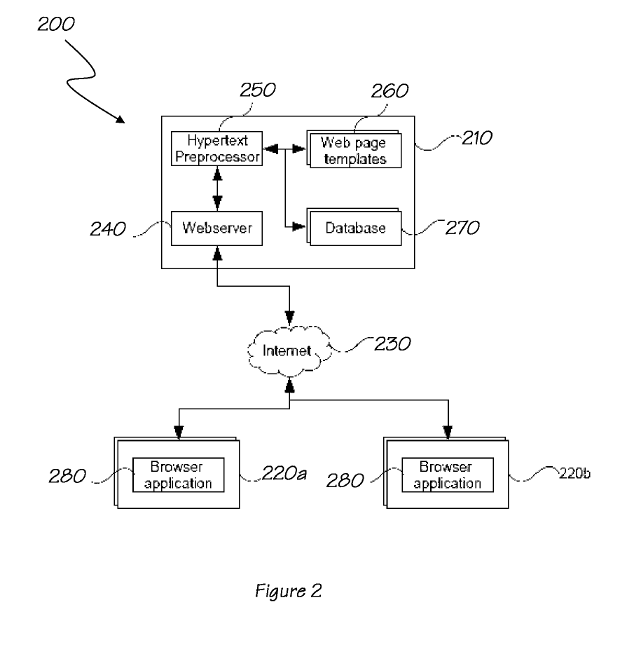

FIG. 2 shows a network 200 of computing devices 100 on which the various embodiments described herein may be implemented. The network 200 comprises a web server 210 for serving web pages to one or more client computing devices 220 over the Internet 230.

The web server 210 is provided with a web server application 240 for receiving requests, such as Hypertext Transfer Protocol (HTTP) and File Transfer Protocol (FTP) requests, and serving hypertext web pages or files in response. The web server application 240 may be, for example the Apache™ or the Microsoft™ IIS HTTP server.

^{[99]} The web server 210 is also provided with a hypertext pre-processor 250 for processing one or more web page templates 260 and data from one or more databases 270 to generate hypertext web pages. The hypertext pre-processor may, for example, be the PHP: Hypertext Pre-processor (PHP) or Microsoft Asp™ hypertext pre-processor. The web server 210 is also provided with web page templates 260, such as one or more PHP or ASP files.

Upon receiving a request from the web server application 240, the hypertext pre-processor 250 is operable to retrieve a web page template, from the web page templates 260, execute any dynamic content therein, including updating or loading information from the one or more databases 270, to compose a hypertext web page. The composed hypertext web page may comprise client side code, such as JavaScript, for Document Object Model (DOM) manipulating, asynchronous HTTP requests and the like.

Client computing devices 220 are provided with a browser application 280, such as the Mozilla Firefox™ or Microsoft Internet Explorer™ browser applications. The browser application 280 requests hypertext web pages

Disclosed herein are training systems for software developers to improve their knowledge also to validate and quantify the experience in developing secure software for secure software applications. The systems disclosed herein have been developed to provide a flexible platform for learning secure coding techniques adaptable to any level of prior knowledge and may be applicable to software developers ranging from entry-level professionals developing their secure coding skills to seasoned experts learning to fix more challenging security vulnerabilities. The specific arrangements of the training system disclosed herein is readily adaptable to support training challenges in the most popular and frequently used programming languages and frameworks including, for example, PHP (Vanilla), Perl, Python (Vanilla), Visual Basic, C#, Java (Vanilla), Java/STRUTS, Java/SPRINT, C/C++ and the like.

The training systems disclosed herein can be used by organisations in a variety of ways, including, but not limited to:
Reduce the number of security weaknesses in production applications;
Evaluate the secure coding skillset of outsourced or offshored developers;
Evaluate the capabilities of new recruits and personnel; and to
Discover and better utilize the security talent among their existing development staff.

Participants begin their training with the system by initially identifying insecure coding practices in their preferred coding language and progress to exercises and challenges that involve identifying and rewriting of any vulnerable lines of code in a given example code snippet demonstrating they have mastered each challenge. The participants unlock achievement levels by successfully completing each of the progressively more difficult challenges which provides them with a tangible measure of their competency in writing secure software code which can be disseminated and compared against other person participants in a selected user group, for example, a team of software developers in an organisation.

The software training application utilises a basic model of commencing participants with a program of simple challenges and, as the participants successfully complete each challenge to an appropriate level of competency, the difficulty of the challenges progressively increases. For example, in particular arrangements of the training systems disclosed herein, the software training application begins by presenting the participants with basic Level 1 challenges and when achieving a passing score, the training system progresses to offering the participant more advanced Level 2 scenarios. Once the participant has completed the Level 2 scenarios to a satisfactory competency, they are presented with Level 3 challenges including exercises involving editing of software code “in-the-browser” which is dynamically evaluated in real-time, instead of the classic multiple-choice assessments which do not provide a high-level indication of the user's competency in actually writing software code. Once a participant has successfully completed the Level 3 challenges, they can then access a fully functioning application that needs to be secured in Level 4. In particular arrangements, the vulnerabilities that participants are challenged with correcting are aligned with OWASP Top 10 web application weaknesses.

In particular arrangements of the software training application, a Hint System is also incorporated into the training platform. This allows a player to request hints for questions they are not sure how to answer. The more hints requested to answer a question, the more points are deducted from the overall score for that question.

In further arrangements, the software training application utilises Confidence Based Learning (CBL) incorporated into the scoring algorithm. For example, in addition to whether a question is answered correctly or not, the score awarded for the question also takes into account other factors, such as speed (time to complete question) and the number of hints used before the particular question is answered. The CBL system is advantageously segregated into a confidence hierarchy as follows:

CBL 1—Classify a vulnerability: Code displayed with vulnerable lines highlighted. Player must classify the vulnerability by selecting the type of vulnerability it is from a list of vulnerability types.

CBL2—Identify vulnerable code block(s): Player is presented with code. They are told what type of vulnerability is present in the code. The player must select the vulnerable code blocks.

CBL 3—Choose best remediation solution: player is presented with vulnerable code, with vulnerable lines highlighted. Player is also presented with multiple versions of the code with alternate possible remediation solutions. Player must select which of the presented solutions is the best remediation solution.

Level 1 challenges focus on CBL 1 and CBL 2 type questions where the player has to identify the vulnerable lines of code and the type of vulnerability. From Level 2 onwards, the questions include CB 1, CBL 2 and CBL 3 questions. Levels are unlimited—there is will always be an unlimited number of levels. The training program will be regularly updated with additional difficulty levels so that a player can continue to progress to higher levels and continue learning.

Advantageously, Level 1 challenges include combination of CBL 1/CBL 2 type questions. All higher challenge levels 2 and above preferably include a combination of CBL 1/CBL 2/CBL 3 type questions.

Progression through the difficulty levels is based on Difficulty of questions and code base and include a number of factors including:
Difficulty—from 0 (Easy) though to 100 (Hard); and
Codebase—from Simple code (1-2 files, approximately 30 lines of code) through to Complex applications comprising multiple flies and 1000s of lines of code.

The higher the difficulty level, the more difficult the question is and the more complex the code presented.

As the participant progresses through the challenges a scorecard of their progress is dynamically generated showing their strengths, areas where further learning is required and also benchmarks their results against other developers in the same group, company or industry.

Particular arrangements of the software training system disclosed herein permit the user undertaking training to choose from a selection of available programming languages in which to undertake the training based on personal experience or development needs. In particular arrangements the selection of available programming languages is dependent on the configuration by the manager. Typically, however the user will be able to switch between programming languages, provided that the particular language is available, to gain exposure to secure programming techniques in a variety of programming languages according to their requirements. Within each programming language, the training system provides a series of progressively more complicated challenges where, for example, each competency level would comprise a predefined number of questions/challenges which need to be successfully solved for the user to progress to more complicated challenges and increased achievement levels.

Competency levels may be assessed by the system in a number of ways, for example, the system may allocate a portion of the available marks for a correct answer to a particular question which then may be supplemented with other measures such as the time taken for the user to present their solution (with particular allowance given for the time for the user to read and comprehend the nature of the question) making up the remainder of the assessment.

To ensure participants gain a true understanding of particular concepts each question may be chosen from a selection of possible questions designed to convey a particular concept. For example, a particular question may be chosen from a question bank containing 5 to 10 (or more) questions of a similar nature. In this manner, where a user gets a question wrong (or skips a particular question), the system may provide a further question from the question bank designed to convey and clarify the specific concept. The system may shuffle the questions from within the question bank and provides the user with a random question from the available questions in the bank in order to assist the user in understanding the concept conveyed by the questions.

Particular arrangements of the training system provide a user interface which incorporates a measure of the user's progress and competency in the selected programming language as they progress through each level of the training system. The system may also provide an indication to the user of the concepts which have been understood and mastered and also those concepts which require the user to develop a greater understanding of the concept so that the user is able to select questions relating to those concepts which need improvement and thus assist in their learning of those concepts.

In particular arrangements of training system the training may be divided into at least three distinct levels of competency, although the system may preferably provide an unlimited number of levels to promote continuous learning for users of all skill competencies. As discussed above, ach level comprises a particular objective in assisting the software developer to learn the required concepts for secure software coding and at each level the user is required to solve increasingly complex problems related to secure code practices such as classifying and/or identifying a security vulnerability in a sample code through to choosing or constructing a remediation solution for a vulnerable section of code.

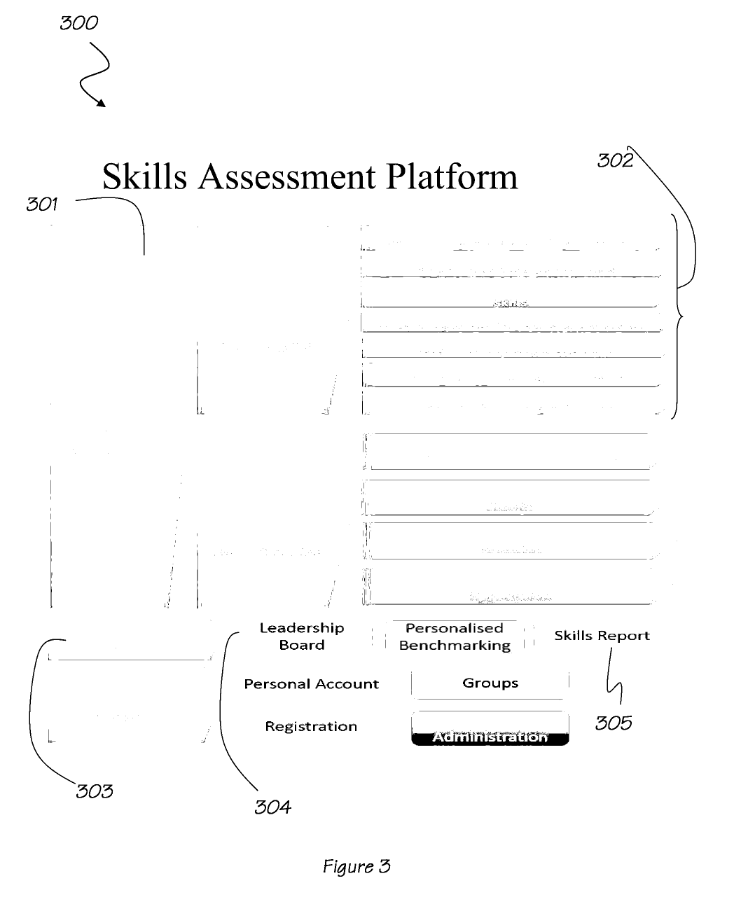

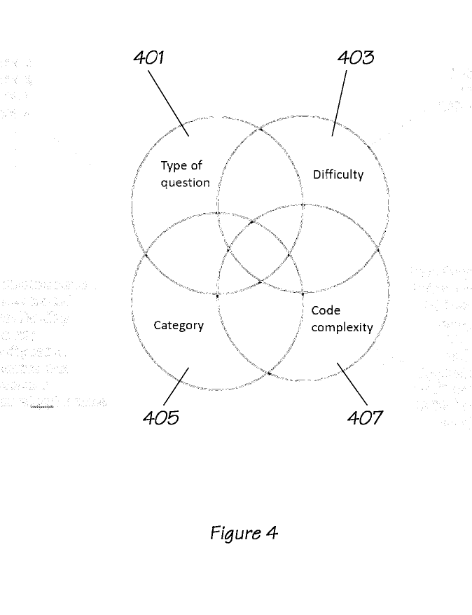

FIG. 3 shows a functional depiction of a skills assessment platform according to the training systems disclosed herein, whereby the platform incorporates such features as secure development skills training and assessment 301 incorporating challenges presented to a participant for development of their technical skills in a variety of development languages including PHP (Vanilla), Perl, Python (Vanilla), Visual Basic, C#, Java (Vanilla), Java/STRUTS, Java/SPRINT and C/C++ as particular examples. These challenges are also presented to a participant in multiple levels of competencies. 302. System 300 also incorporates reporting systems 303 including ranking 304 of participant's progress and competency through the skills assessment process, and provision of reports 305 on the particular participants progress and competency in the appropriate skills. FIG. 4 shows a representation of the factors incorporated into the challenges including the type of question 401 selected from the CBL categories, CBL 1, CBL 2 etc.; the challenge difficulty 403 on a scale of, for example, 0 to 100; a particular category 405 of challenge question; and the code complexity 407 ranging from simple code (1-2 files, approximately 30 lines of code) through to Complex applications comprising multiple flies and 1000s of lines of code.

### Example Use Cases

As would be appreciated by the skill addressee, the training system may be adapted depending on the role of the participant. For example, in the case of a software developer i.e. a developer who is looking for employment and wants to use the assessment results of the training system to show to their employer or potential employer of their competency in developing secure software code and applications. In this case, the software developer would utilise the Level-based assessment system of the training system and play the challenges presented with the view to increasing their knowledge and obtaining an objective assessment of their competency based on their progress through the training system, whereby the developer may choose to compare their progress and/or competency levels with other participants using the training system on the basis of an appropriate sub-set of participants, for example, the software developer may compare their results with other participants in their industry, region, age, or organisation, among other possible sub-sets of participants. The training system may further offer a detailed assessment certificate which may be accessible for purchase by the developer as a tangible measure of their particular competency developing secure software code in one or more relevant software programming languages.

In a further example, the manager of a software development team may utilise the system to assist in the learning of his team members in secure software code techniques also to assess the level of competency of each of the manager's team members. In this example, the manager may be able to use the training system is disclosed herein to manage and observe the progress of a group of users. In this example the manager would be provided with the ability to enter and view the details and progress results of each team members. In this particular case, the system may be readily adapted to assessment of participants undertaking a formalised education course, for example a university course, or alternatively may be applied by management of a particular company which employs software developers. In particular arrangements of the manager may be able to create, edit or delete participant accounts for the members of his group, and optionally may be able to configure the development language or type of challenges for his/her group depending on the coding requirements of the group. Of course in this example the manager account would be provided the opportunity to produce reports on the competency of the members of the group at an appropriate level of detail according to their requirements (e.g., both high-level and detailed reports may be available).

In a further example, the training is disclosed herein may also be used by recruiters who may be seeking potential recruitment hires having a specific skill set and/or competency in developing secure software code in a particular language. In this case the recruiter may be for the opportunity to search through a database of system participants (where such participants had to receive contact recruiters in accordance with privacy requirements) and the recruiter may be able to directly contact a particular discipline or selection of participants fitting the recruiters predefined criteria. In certain arrangements the recruiter may also be able to generate reports on particular participants, and such reports may be anonymous depending on either the participant's level of consent to provide such competency information to potential recruiters and also depending on the requirements of the recruiter in terms of presenting a potential candidate to a possible employer.

In a further example, the purchaser of software developed by a vendor (outsourced and/or offshored) may utilise the system to assess the competency of the vendor's development team in secure software code. In this example, the manager may be able to use the training system disclosed herein to manage and observe the progress of a group of users. In this example, the manager would be provided with the ability to enter and view the details and progress results of each team members. In particular arrangements, the manager may be able to create, edit or delete participant accounts for the members of his group, and optionally may be able to configure the development language or type of challenges for his/her group depending on the coding requirements of the group. Of course in this example the manager account would be provided the opportunity to produce reports on the competency of the members of the group at an appropriate level of detail according to their requirements (e.g., both high-level and detailed reports may be available).

Additional features that may be incorporated into the presently disclosed training systems may include a computer system that may be used as a Challenge Management Portal tool to manage the various exercises and challenges offered by the training system as the user progresses, for example, the Challenge Management Portal may be able to manage submission, review and approval of the exercises and challenges utilised in the various levels of the training system. As will be readily appreciated, the Challenge Management Portal may be adapted to hold and manage all exercises and challenges available in the training system program and may be further adapted to accept challenges to be entered into the training system by external consultants and experts who may be employed to develop such challenges for the training system. The challenge Management Portal may be adapted for such external consultants and experts to enter details specific to the particular challenges they are supplying including such details as the function of the code snippets provided, a district description of the vulnerabilities incorporated in the code snippet, one or more possible solutions to make the code snippet secure one and an indication of the difficulty level of the challenge being supplied.

It will be readily appreciated that the training system is disclosed herein include significant advantages over existing training methods and systems and includes a plurality of unique attributes including the gamification of the learning process through a series of challenges and achievement levels for the participants to attain and compare their individual progress between acquaintances and work colleagues. In further arrangements the training system may be integrated with one or more social media platforms such that participants in the training system program may choose to publish or promote their progress through the system and may directly compete with their acquaintances via the social media platform.

As discussed above the training system disclosed herein goes beyond simple multiple-choice answer question varieties and includes such real-time systems to provide immediate feedback to the participant of their ability to write secure code by provision of a system where example code snippets must be rewritten to make the code snippet secure whereby the rewritten code submitted by the participant can be analysed by the training system operator and feedback provided to the participant. Such analysis and feedback may be provided in real time as the participant attempts each challenge. As discussed above, the system extends the challenges for participants to the level of being provided with the software code for an example application, whereby the participant must analyse the software code and rewrite the code to make the software application secure.

Further advantages of the presently disclosed training systems include that the learning process may be completely self-managed by a participant, or the participant's progress may be managed and/or guided by the participant's employer or manager, and the participant (and/or their manager) is provided with constant feedback as to the participant's progress and competency in their ability to write secure software code. This feedback provided to participants may readily be utilised as a benchmark to compare the participant's competency in real-work scenarios requiring secure software code which is directly relevant to the requirements of the software community for securing their software applications against the vulnerabilities common in the industry across a wide range of programming languages, e.g. PHP (Vanilla), Perl, Python (Vanilla), Visual Basic, C#, Java (Vanilla), Java/STRUTS, Java/SPRINT and C/C++ among many others. The training system disclosed herein is also based upon an automated system which is readily scalable for large numbers of participants to undergo training in secure software coding techniques at their own pace, and one which provides relevant feedback a particular software developers competency in terms of their ability to write secure software code, and which may be used as a consistent benchmark for comparison of software developers capabilities that may be used as a recruitment tool or to for selection of appropriate developers for a specific project having particular security requirements.

It will be appreciated that the methods/apparatus/devices/systems described/illustrated above at least substantially provide systems and methods utilising a software application for training of software developers to learn secure coding techniques.

The secure software code training systems and methods described herein, and/or shown in the drawings, are presented by way of example only and are not limiting as to the scope of the invention. Unless otherwise specifically stated, individual aspects and components of the systems and methods may be modified, or may have been substituted therefore known equivalents, or as yet unknown substitutes such as may be developed in the future or such as may be found to be acceptable substitutes in the future. The systems and methods may also be modified for a variety of applications while remaining within the scope and spirit of the claimed invention, since the range of potential applications is great, and since it is intended that the present systems and methods be adaptable to many such variations.

### Interpretation

### Bus

In the context of this document, the term “bus” and its derivatives, while being described in a preferred embodiment as being a communication bus subsystem for interconnecting various devices including by way of parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like, should be construed broadly herein as any system for communicating data.

In Accordance with

As described herein, ‘in accordance with’ may also mean ‘as a function of’ and is not necessarily limited to the integers specified in relation thereto.

### Composite Items

As described herein, ‘a computer implemented method’ should not necessarily be inferred as being performed by a single computing device such that the steps of the method may be performed by more than one cooperating computing devices.

Similarly objects as used herein such as ‘web server’, ‘server’, ‘client computing device’, ‘computer readable medium’ and the like should not necessarily be construed as being a single object, and may be implemented as a two or more objects in cooperation, such as, for example, a web server being construed as two or more web servers in a server farm cooperating to achieve a desired goal or a computer readable medium being distributed in a composite manner, such as program code being provided on a compact disk activatable by a license key downloadable from a computer network.

### Database

In the context of this document, the term “database” and its derivatives may be used to describe a single database, a set of databases, a system of databases or the like. The system of databases may comprise a set of databases wherein the set of databases may be stored on a single implementation or span across multiple implementations. The term “database” is also not limited to refer to a certain database format rather may refer to any database format. For example, database formats may include MySQL, MySQLi, XML or the like.

### Wireless

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

### Processes

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

### Processor

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Computer-Readable Medium

Furthermore, a computer-readable carrier medium may form, or be included in a computer program product. A computer program product can be stored on a computer usable carrier medium, the computer program product comprising a computer readable program means for causing a processor to perform a method as described herein.

### Networked or Multiple Processors

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

### Carrier Medium

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

### Implementation

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Means for Carrying Out a Method or Function

Furthermore, some of the embodiments are described herein as a method or combination of elements of a method that can be implemented by a processor or a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

### Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

### Arrangements:

Reference throughout this specification to “one arrangement” or “an arrangement” means that a particular feature, structure or characteristic described in connection with the embodiment is included in at least one arrangement of the systems disclosed herein. Thus, appearances of the phrases “in one arrangement” or “in an arrangement” in various places throughout this specification are not necessarily all referring to the same arrangement, but may. Furthermore, the particular features, structures or characteristics may be combined in any suitable manner, as would be apparent to one of ordinary skill in the art from this disclosure, in one or more arrangements.

Similarly it should be appreciated that in the above description of example arrangements of the invention, various features of the invention are sometimes grouped together in a single arrangement, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed arrangement. Thus, the claims following the Detailed Description are hereby expressly incorporated into this Detailed Description, with each claim standing on its own as a separate arrangement of this invention.

Furthermore, while some arrangements described herein include some but not other features included in other arrangements, combinations of features of different arrangements are meant to be within the scope of the invention, and form different arrangements, as would be understood by those in the art. For example, in the following claims, any of the claimed arrangements can be used in any combination.

### Specific Details

In the description provided herein, numerous specific details are set forth. However, it is understood that s of the invention may be practiced without these specific details. In other instances, well-known methods, structures and techniques have not been shown in detail in order not to obscure an understanding of this description.

### Terminology

In describing particular arrangements of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: “including” or “which includes” or “that includes” as used herein is also an open term that also means “including at least” the elements/features that follow the term, but not excluding others. Thus, including is synonymous with and means comprising.

### Scope of Invention

Thus, while there has been described what are believed to be the preferred arrangements of the invention, those skilled in the art will recognize that other and further modifications may be made thereto without departing from the spirit of the invention, and it is intended to claim all such changes and modifications as fall within the scope of the invention. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the mobile device industries, specifically for methods and systems for distributing digital media via mobile devices.

1. A training system for providing training facilities for secure coding techniques, the training system comprising:
a computer server system comprising one or more computer processors and memory for storing computer code, said computer code, when executed by said processors, being adapted to;
provide means for provision of a plurality of unique user accounts and means for a user to securely access an associated user account;
serve insecure software code example snippets to a user interface for said user to identify one or more vulnerabilities in said insecure software code example snippets;
process a solution to said one or more vulnerabilities in said insecure software code example snippets, said solution being entered via a user interface by said user; and
provide feedback to said user regarding the validity of said solution.

2. A training system as claimed in claim 1 wherein said solution comprises a choice by said user from a selection of possible solutions.

3. A training system as claimed in claim 1 wherein said solution comprises amended software code submitted by said user.

4. A training system as claimed in claim 1 wherein said feedback to said user is indicative of a level of competency of said user with secure coding techniques.

5. A training system as claimed in claim 1 wherein said user comprises a software developer.

6. A training method for training users in secure software coding competency, said method comprising the steps of:
providing a computer server system comprising one or more computer processors and memory for storing computer code, said computer code, when executed by said processors, being adapted to serve a training system to said users;
providing means for provision of a plurality of unique user accounts and means for said users to securely access an associate account;
serving examples of insecure software code snippets to a user interface for said user to identify one or more vulnerabilities in said insecure software code example snippets;
processing a solution to said one or more vulnerabilities in said insecure software code example snippets, said solution being entered via a user interface by said user; and
providing feedback to said user regarding the validity of said solution.

7. A method as claimed in claim 6, wherein said serving of insecure coding examples to said user interface comprises accompanying said example code snippets with a plurality of possible solutions for review and selection by said user of one of said possible solutions for review.

8. A method as claimed in claim 6, wherein said solution entered by said user comprises software code necessary to transform said insecure software code example into a secure software code snippet.

9. A method as claimed in claim 6 wherein said feedback provided to said user comprises a competency rank for said user with respect to a selected group or sub-set of users registered with the training system.

10. A method as claimed in claim 9, wherein said selected subset of users comprises a plurality of user associated with a common employer.

11. A method as claimed in claim 6 wherein said user comprises a software developer.

12. A computer program product having a computer readable medium having a computer program recorded therein for providing training facilities for users to learn secure coding techniques said computer program product comprising:
means for provision of a plurality of unique user accounts and means for a user to securely access an associated user account;
an application module adapted to serve insecure software code example snippets to a user interface for said user to identify one or more vulnerabilities in said insecure software code example snippets;
providing an input means to allow said user to enter via a user interface a solution to said one or more vulnerabilities in said insecure software code example snippets;
a processing application module for processing the solution; and
providing feedback to said user regarding the validity of said solution.

13. A computer program product as claimed in claim 12 wherein said computer program product further comprises a ranking application module adapted to determine a competency rank for said user with respect to a selected group or sub-set of users registered with the training system.

14. A computer program for providing training facilities for users to learn secure coding techniques, said program comprising:
code for provision of a plurality of unique user accounts and means for a user to securely access an associated user account;
code for serving insecure software code example snippets to a user interface for said user to identify one or more vulnerabilities in said insecure software code example snippets;
code for processing a solution to said one or more vulnerabilities in said insecure software code example snippets, said solution being entered via a user interface by said user; and
code for providing feedback to said user regarding the validity of said solution.

15. A computer program element comprising computer program code means to make a computer execute a procedure to providing training facilities for users to learn secure coding techniques, said computer program element comprising:
code for provision of a plurality of unique user accounts and means for a user to securely access an associated user account;
code for serving insecure software code example snippets to a user interface for said user to identify one or more vulnerabilities in said insecure software code example snippets;
code for processing a solution to said one or more vulnerabilities in said insecure software code example snippets, said solution being entered via a user interface by said user; and
code for providing feedback to said user regarding the validity of said solution.

16. A computer readable medium, having a program recorded thereon, where the program is configured to make a computer execute a procedure to provide training facilities for users to learn secure coding techniques, the procedure comprising:
providing means for provision of a plurality of unique user accounts and means for a user to securely access an associated user account;
serving insecure software code example snippets to a user interface for said user to identify one or more vulnerabilities in said insecure software code example snippets;
processing a solution to said one or more vulnerabilities in said insecure software code example snippets, said solution being entered via a user interface by said user; and
providing feedback to said user regarding the validity of said solution.

17-22. (canceled)
